(19) United States
(12) Patent Application Publication
(10) Pub. No.: US 2022/0052436 A1
(43) Pub. Date: Feb. 17, 2022

(54) CHANNEL INFORMATION-BASED FREQUENCY TUNING OF ANTENNAS

(71) Applicant: Hewlett-Packard Development Company, L.P., Spring, TX (US)

(72) Inventors: Yao Cheng Yang, Taipei City (TW); Chun-Chih Liu, Taipei City (TW); Yi-Ching Lin, Taipei City (TW); Tzu-Chiang Cheng, Taipei City (TW); Tsung-Teng Wang, Taipei City (TW); Chia-Hung Kuo, Taipei City (TW); Ming-Shien Tsai, Taipei City (TW); Hung-Wen Cheng, Taipei City (TW); Isaac Lagnado, Spring, TX (US)

(73) Assignee: HewlettPackard Development Company, L.P., Spring, TX (US)

(21) Appl. No.: 17/288,549

(22) PCT Filed: Apr. 30, 2019
(86) PCT No.: PCT/US2019/029823

§ 371 Date: Apr. 25, 2021

(51) Int. Cl. H01Q 1/22; H01Q 21/28; H01Q 5/30; H01Q 5/50; H04B 1/04; H04B 1/401

(52) U.S. Cl. CPC H01Q 1/2266; H01Q 1/2291; H01Q 21/28; H04B 1/401; H01Q 5/50; H04B 1/0458; H01Q 5/30

(57) ABSTRACT

In one example, a computing device may include an antenna, a tuning circuit to tune the antenna, a wireless local area network (WLAN) module coupled to the antenna, a system firmware to boot up the computing device, and a look-up table residing in the system firmware. The system firmware may receive channel information from the WLAN module, determine a state of the antenna corresponding to the received channel information using the look-up table, and tune a frequency of the antenna corresponding to the determined state via the tuning circuit.

### BACKGROUND

Electronic devices such as notebook computers, tablets, and mobile phones are often provided with wireless communications capabilities. To satisfy consumer demand for small form factor wireless electronic devices, manufacturers are continually striving to implement wireless communications circuitry such as antenna components using compact structures. At the same time, there is a desire for wireless devices to cover a growing number of communications bands (e.g., 2.4 GHz, 2.5 GHz, 5 GHz, and the like). Such electronic devices may use radio communications to transmit sound signals, video signals, and data.

### BRIEF DESCRIPTION OF THE DRAWINGS

Examples are described in the following detailed description and in reference to the drawings, in which:

FIG. 1A is a block diagram of an example computing device, including a system firmware to tune a frequency of an antenna based on channel information;

FIG. 1B is a block diagram of the example computing device of FIG. 1A, depicting additional features;

FIG. 2 illustrates an example method for switching a state of an antenna based on channel information;

FIG. 3A depicts an example look-up table including mapping information to map general-purpose input outputs (GPIOs) to different antenna states;

FIG. 3B shows another example look-up table including predetermined channel information and corresponding antenna states;

FIG. 4A is a schematic representation of an example electronic device, depicting a system firmware to switch an antenna to operate in a determined state via toggling reserved GPIOs;

FIG. 4B is a schematic representation of the example electronic device of FIG. 4A, depicting additional features;

FIG. 5 is a block diagram of an example computing device including a non-transitory machine-readable storage medium, storing instructions to tune a frequency of an antenna based on channel information; and

FIG. 6 illustrates an example graph depicting a frequency versus signs strength characteristics of an antenna corresponding to different antenna states.

### DETAILED DESCRIPTION

Radio communications may be widely used in environments including sound signal transmission, video signal transmission, and data transmission. In various radio communication technology environments, radio receivers may be used to receive radio waves intercepted by antennas and to convert the information carried by the radio waves into usable forms. For example, through a demodulation process, a radio receiver may convert the information into sound signals, video signals, data, or other useful signals.

For industrial, scientific, medical, and other purposes, various radio frequency devices (e.g., computing devices) may transmit and receive radio frequency signals at radio bands, which are collectively labeled as the industrial, scientific and medical (ISM) bands. In recent years, these ISM bands have become popular among short-range low power communications systems. For example, the 2.4 GHz band may be used by the computing devices such as cordless phones, Bluetooth devices, near field communication (NFC) devices, ZigBee devices, wireless network devices, and the like. Because there are many different usages of the ISM bands, the emissions of the computing devices operating at the ISM bands can create electromagnetic interferences and may disrupt the radio communications of other devices at the same or nearby frequency.

Further, these computing devices may include metallic, cases, which may create a challenge to design an antenna for such computing devices as the metallic cases can act as a shield that prevents electromagnetic energy from reaching the antenna.

Furthermore, there can be interferences between wireless local area networks (WLANs), for instance. The number of WLANs deployed increases every year. Both corporate entities and private families deploy WLANs. In some occasions, there may be no coordination between the WLAN networks during the planning and deployment stages. Therefore, computing devices within a WLAN network can have an interference generated by devices of other WLAN networks. The interference problem may become even more prominent when the network devices have better signal ranges.

In addition, an antenna's performance can be impacted by the operating environment. For example, multiple use cases can exist for computing devices, during which a user's hand may get closer to or even cover the antenna, and hence significantly impair the antenna's radiated efficiency.

When a computing system or computing device is powered on, the computing device may undergo an initial set of operations to configure the hardware and programming of the computing device. This process may refer to as a boot process. The boot process may be performed using a system firmware such as a basic input/output system (BIOS), unified extensible firmware interface (UEFI), or the like. The system firmware may be implemented in hardware, machine-readable instructions, or a combination thereof. The firmware may be stored on a chip (e.g., an embedded controller) located on a motherboard of the computing device. The system firmware may refer to a boot program that can be executed as instructions when the computing device is first powered on along with a set of configurations specified for the system firmware. The system firmware and associated configurations may be stored in a non-volatile memory such as a non-volatile random-access memory (NVRAM) or a read-only memory (ROM). The system firmware may recognize, initialize, and test hardware present in the computing device based on the set of configurations.

After the power button is activated, the computing device may first load in the system firmware to perform tasks such as performing power-on self-test (POST), detecting hardware, installing drivers, and loading an operating system (OS). The system firmware then gives control of the computing device to the OS. The system firmware may provide an interface to allow a variety of different parameters to be set.

In the examples described herein, the system firmware may receive channel information (e.g., a channel number, channel bandwidth, frequency band, received signal strength indicator (RSSI), and the like) from a WLAN module (e.g., WLAN driver). Further, the system firmware may determine an antenna state corresponding to the channel information using a look-up table. For example, the look-up table may include tuning states to tune an antenna for transmit and receive applications as a function of predetermined channel information, such as a frequency channel, a channel bandwidth, and a frequency band. In one example, the system firmware may employ artificial intelligence to determine the antenna state. Further, the system firmware may tune the antenna corresponding to the determined antenna state, for instance, using general-purpose input outputs (GPIOs).

Examples described herein may enhance WLAN throughput performance by switching antennas into an optimized state for having an enhanced antenna gain and Wi-Fi signal strength, like operating frequency switching and antenna pattern switching. Examples described herein may enable users to have an enhanced online surfing experience. Further, examples described herein may enable antennas to shift the frequency back to counteract the impacts caused by frequency shifts due to system-based or hands getting closer to the antennas, and thereby provide an optimized antenna signal strength.

Further, examples described herein may detune antennas when there is specific absorption rate (SAR) concern. Such conditional detuning of the antennas can be applied to SAR applications, Time-Average SAR applications, and can be an alternative during low power time period. In this example, the antennas can be conditionally detuned instead of lowering conductive power of WLAN modules.

Examples described herein can be implemented in devices with WLAN design environments, such as windowless antennas (e.g., metal housings), narrow borders, hinges, and the like and with antennas suffering from channel bandwidth and antenna radiation coverage issues.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

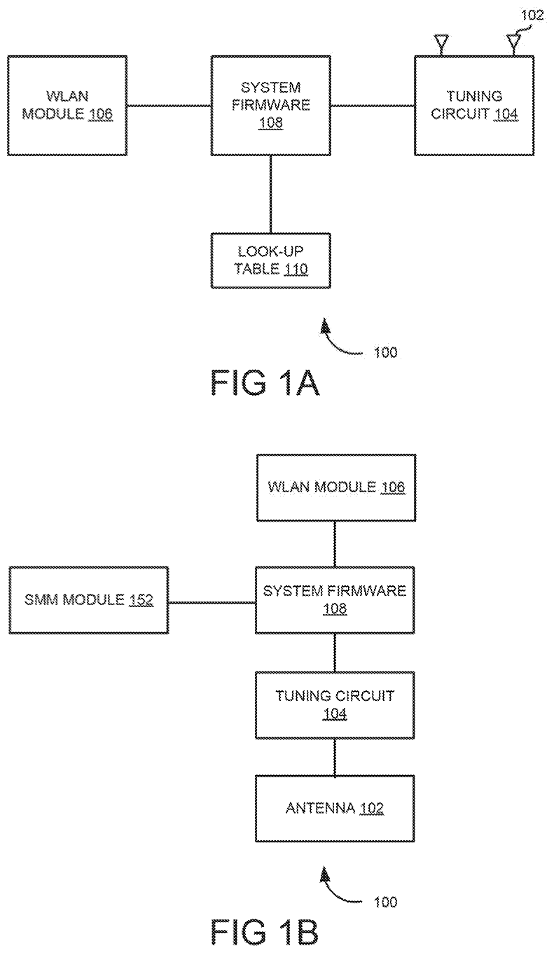

Turning now to the figures, FIG. 1A is a block diagram of an example computing device 100, including a system firmware 108 to tune a frequency of an antenna 102 based on channel information. Example computing device 100 may include a notebook, tablet, personal computer (PC), smart phone, gaming laptop, workstation, or the like.

Computing device 100 may include antenna 102. Example antenna 102 may include a dipole antenna, monopole antenna, patch antenna, loop antenna, microstrip antenna, or any other type of antenna suitable for transmission of radio frequency (RF) signals. Further, computing device 100 may include a tuning circuit 104 to tune antenna 102 over multiple frequency bands. Furthermore, computing device 100 may include a WLAN module 106 communicatively coupled to antenna 102. For example, WLAN module 106 may be a WLAN driver that enables computing device 100 to run and configure a WLAN device such as a router, a wireless card, a wireless Internet adapter, or the like. WLAN module 106 may also store statistics associated with frequency channels (i.e., channel information). Further, computing device 100 may include system firmware 108 to boot up computing device 100. Example system firmware 108 may include BIOS, UEFI, or the like.

System firmware 108 may be implemented in hardware, machine-readable instructions, or a combination thereof. Further, system firmware 108 may be implemented as engines or modules including any combination of hardware and programming to implement the functionalities described herein.

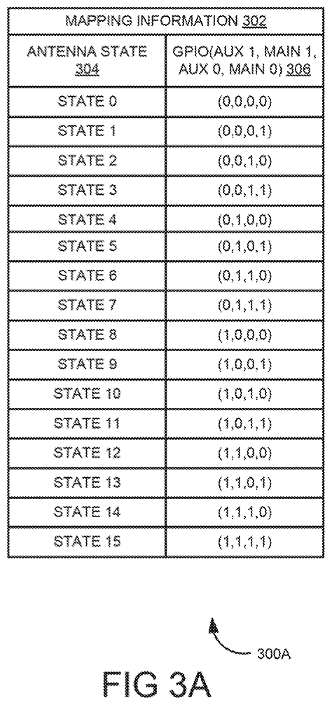

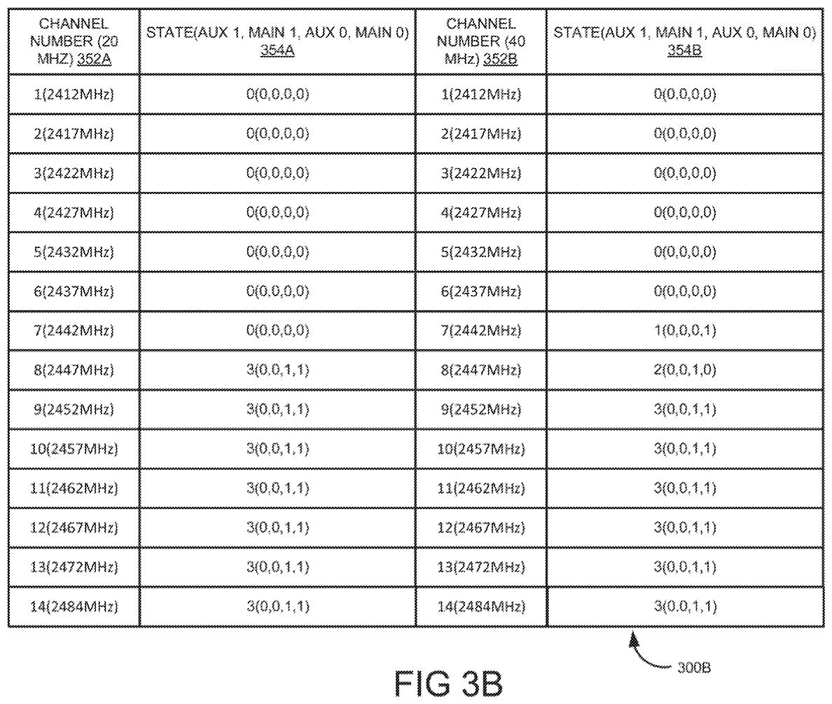

Further, computing device 100 may include a look-up table 110 residing in or accessed by system firmware 108. In some examples, look-up table 110 may be stored in memory that can be accessible by system firmware 108. An example look-up table 110 is shown in FIGS. 3A and 3B. In one example, look-up table 110 may be generated during the test phase by automatically establishing a connection with an access point, changing channel and/or channel bandwidth settings of the access point during the test phase, recording GPIO states associated with each channel and/or channel bandwidth while changing channel and/or channel bandwidth settings, and filling/updating look-up table 110 using the recorded values.

During operation, system firmware 108 may receive the channel information from WLAN module 106. Example channel information can be selected from a group consisting of a channel number, a channel bandwidth, a frequency band, and a received signal strength indicator (RSSI) value. Further, system firmware 108 may determine a state of antenna 102 corresponding to the received channel information using look-up table 110.

In one example, system firmware 108 may determine the state of antenna 102 by generating a system management interrupt that causes computing device 100 to enter a system management mode upon receiving the channel information, re-packet the channel information with a system management mode protocol during the system management mode, and determine the state of antenna 102 by analyzing the re-packeted channel information using look-up table 110 during the system management mode. Thus, system firmware 108 may provide security and prevent hackers or virus attacks that can impact Wi-Fi performance.

Furthermore, system firmware 108 may tune a frequency of antenna 102 corresponding to the determined state via tuning circuit 104. In one example, system firmware 108 may control tuner circuit 104 to adjust antenna 102 to operate at frequency associated with the determined state. Example tuning circuit 104 may include an RF switching circuitry (e.g., metal oxide silicon field effect transistor (MOSFET), diode, or the like) and a tuning component such as a tunable, inductor, tunable capacitor, or any other tunable component. In other examples, the tuning component may be implemented based on a switch function, which can be realized by different switches, diodes, aperture tuner chipset, impedance chipset with general purpose input outputs (GPIOs), serial peripheral interface bus (SPI), mobile industry processor interfaces (MIPIs), or the like.

In the above example, system firmware 108 may issue control signals that adjust inductance values, capacitance values, or other parameters associated with tuning circuit 104, thereby tuning antenna 102 to the determined state. In other examples, tuning circuit 104 can be controlled by a logic circuit that can be implemented in the switching circuitry via the GPIOs, SPIs, MIPIs, or the like.

In another example, system firmware 108 may detune antenna 102 when there is a specific absorption rate (SAR) concern. In this example, detuning antenna 102 may allow for reduced SAR exposure to a user of computing device 100. For example, when computing device 100 is placed into a convertible mode, the system management mode may predict that the user is in close proximity to antenna 102, and therefore the system management mode may trigger a request to detune antenna 102. In this example, system firmware 108 may select tuning in look-up table 110 that is not optimal (i.e., with respect to range performance), but is instead preferred with respect to reduced SAR exposure for that specific antenna 102 and thereby degrades the performance of antenna 102 for that specific frequency, channel and/or band. Subsequently, when computing device 100 is placed into a laptop mode, the system management mode may assume that a user may be no longer in proximity to antenna 102 and hence tune antenna 102 by selecting tuning associated with an optimal range performance of antenna 102 with respect to frequency, band, and the like.

In the above example, when detuning is requested, an additional column may be added to look-up table 110, with an appropriate detuning selection for each frequency/band entry. In addition, multiple detuning options may be provided in look-up table 110, for example, such that a first column may detune antenna 102 by 2 dB, a second column may detune antenna 102 by 4 dB, and a third column may detune antenna 102 by 6 dB. Thus, the system management mode may select an optimal detuning option based on the operating mode (e.g., laptop mode, tablet mode, tent mode, or the like) of computing device 100. For example, some operating modes may not need maximum detuning. In this case, the system management mode may decide that the tent mode may require only 2 dB of detuning whereas the tablet mode may require 6 dB of detuning, for instance.

FIG. 1B is a block diagram of example computing device 100 of FIG. 1A, depicting additional features. For example, similarly named elements of FIG. 1B may be similar in structure and/or function to elements described with respect to FIG. 1A. As shown in FIG. 1B, computing device 100 may include a system management mode (SMM) module 152. During operation, system firmware 108 may receive the channel information from WLAN module 106 and send the channel information to SMM module 152. In one example, SMM module 152 may determine the state of antenna 102 by generating system interrupt as explained with respect to FIG. 1A and return the determined state to system firmware 108. Further, system firmware 108 may switch antenna 102 to operate in the determined state via GPIOs.

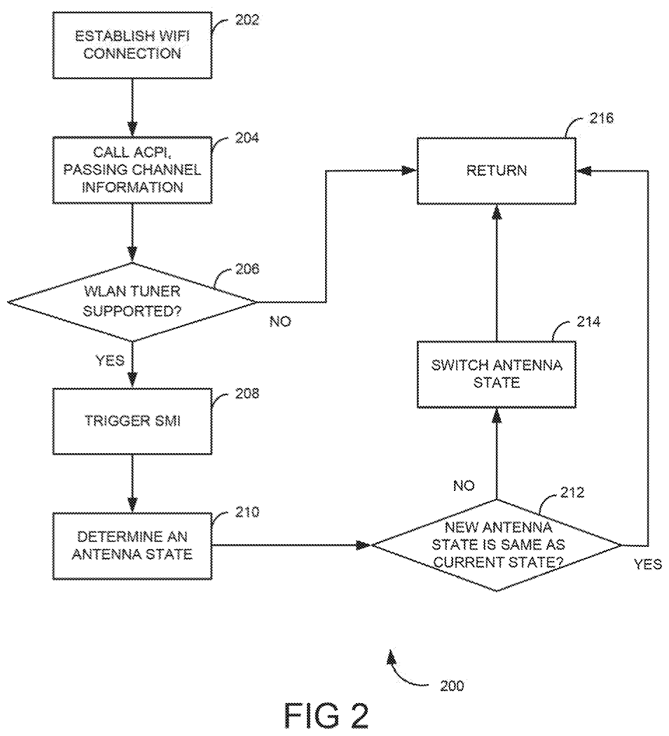

FIG. 2 illustrates an example method for switching a state of an antenna based on channel information. At 202, a wireless network connection (e.g., Wi-Fi) may be established for a computing device. At 204, an advanced configuration and power interface (ACPI) may be called and the channel information may be passed from a WLAN module to a system software of the computing device. At 206, a check may be made to determine whether the WLAN tuning capability is supported. If the WLAN tuning capability is not supported, the process may terminate at 216. If the WLAN tuning capability is supported, then a system management interrupt (SMI) may be triggered causing the computing device to enter a system management mode, at 208. During the system management mode, an antenna state may be determined using a look-up table, at 210. An example look-up table is shown in FIGS. 3A and 3B.

FIG. 3A depicts an example look-up table 300A including mapping information 302 to map GPIOs 306 to different antenna states 304. Each antenna state may have a different GPIOs state. For example, as shown in FIG. 3A, state 0 corresponds to GPIOs (0, 0, 0, 0), state 1 corresponds to GPIOs (0, 0, 0, 1), state 2 corresponds to GPIOs (0, 0, 1, 0), and the like. In this example, the GPIOs corresponding to the determined state can be outputted to a tuning circuit of the computing device to switch the antenna state. The entries of look-up table 300A can be incorporated into look-up table 3006 to depict predetermined channel information and corresponding antenna states.

Particularly, FIG. 38 shows an example look-up table 3006 including predetermined channel information and corresponding antenna states. Look-up table 3006 may depict four GPIOs corresponding to each antenna state. In one example, look-up table 3006 may include predetermined antenna states to tune an antenna for transmit and receive applications as a function of a frequency channel, a channel bandwidth, and a frequency band. As shown in FIG. 36, look-up table 3006 may depict channel information (i.e., channel number and associated channel bandwidth) corresponding to a frequency band (e.g., 2.4 GHz) in columns 352A and 3526. Further, look-up table 3006 may depict an antenna state and associated GPIOs corresponding to the channel information in columns 354A and 3548.

In one example, consider that the frequency to be used through the antenna in the determined state is 2447 MHz and the frequency used through the antenna in a current state is 2432 MHz corresponding to 20 MHz channel bandwidth. In this example, the system firmware may transmit a control signal (i.e., control data (0, 0, 1, 1)) corresponding to 2447 MHz to the tuning circuit so as to adjust the frequency used by the antenna to be 2447 MHz in 20 MHz channel bandwidth (e.g., to operate in antenna state 3).

In another example, consider that the frequency to be used through the antenna in the determined state is 2447 MHz and the frequency used through the antenna in a current state is 2432 MHz corresponding to 40 MHz channel bandwidth. In this example, the system firmware may transmit a control signal (i.e., control data (0, 0, 1, 0)) corresponding to 2447 MHz to the tuning circuit so as to adjust the frequency used by the antenna to be 2447 MHz in 40 MHz channel bandwidth (e.g., to operate in antenna state 2). The example look-up tables 300A and 300B are intended to be illustrative and non-limiting. In another example, look-up tables 3006 may include any number entries corresponding to multiple frequency bands (e.g., 2.4 GHz, 5 GHz, and the like) and multiple channel bandwidths (e.g., 20 MHz, 40 MHz and the like) corresponding to each frequency band.

Referring back to FIG. 2, at 212, the determined antenna state (i.e., new antenna state) may be compared to a current antenna state. If the determined antenna state is same as the current antenna state, the process may terminate at 216. If the determined antenna state is different from the current antenna state, then the antenna state may be switched to the determined antenna state by using GPIOs corresponding to the determined state, at 214. In this example, the look-up table may indicate that the current antenna state may be an optimized tuning state, or may indicate that a different antenna state may be the optimized tuning state. Accordingly, system firmware 408 may send GPIOs (i.e., control data) corresponding to the optimized tuning state to tune the antenna.

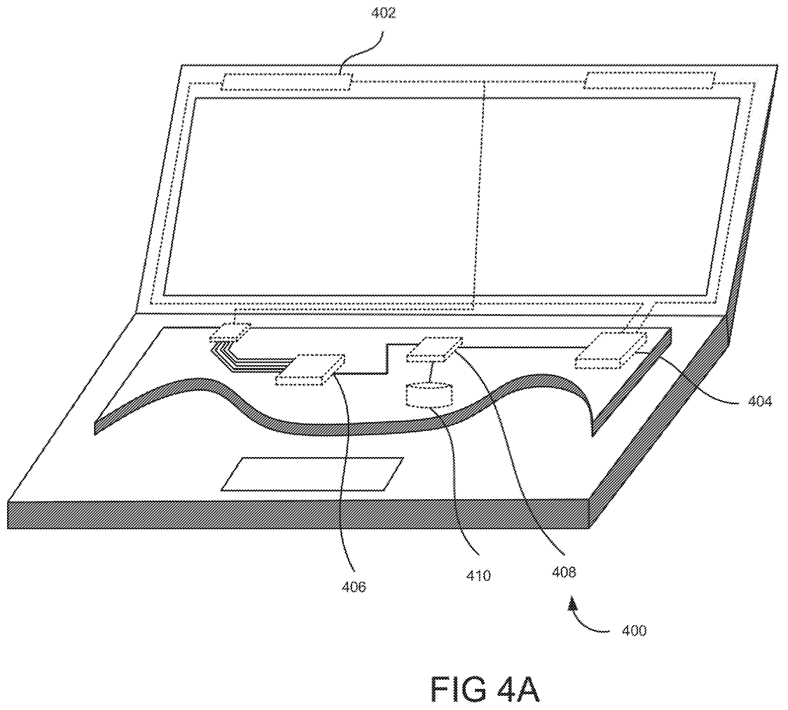

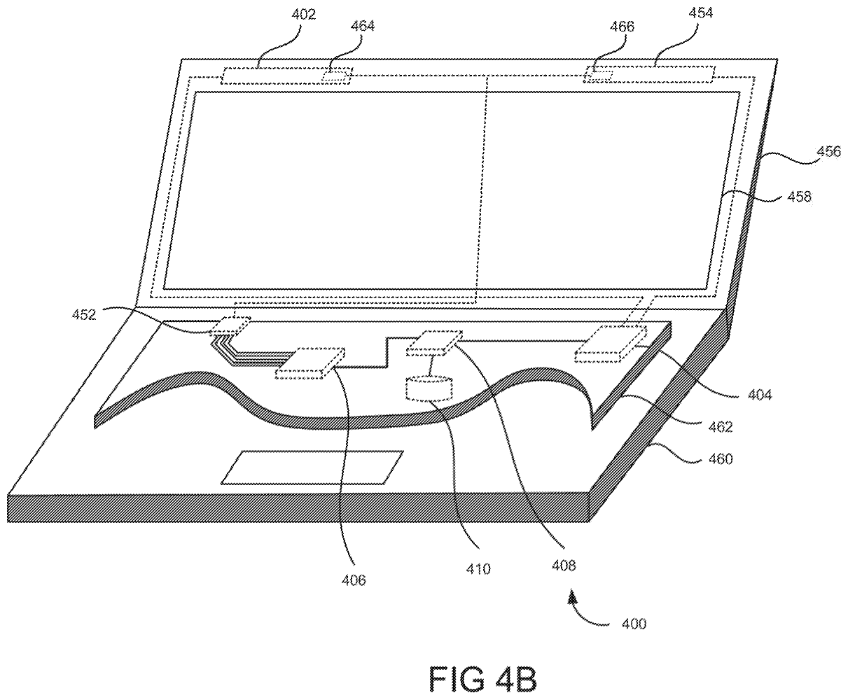

FIG. 4A is a schematic representation of an example electronic device 400, depicting a system firmware 408 to switch an antenna to operate in a determined state via toggling reserved GPIOs. Example electronic device 400 may be a personal computer, a notebook computer, a tablet computer, a convertible device, a personal gaming device, and the like. Example convertible device may refer to a device that can be “convertible” from a laptop mode to a tablet mode.

Electronic device 400 may include a first antenna 402 having a tuning capability. Further, electronic device 400 may include a WLAN module 404 coupled to first antenna 402. Furthermore, electronic device 400 may include a platform controller hub 406 communicatively coupled to first antenna 402 and having the reserved GIPOs to control first antenna 402. Further, pin names associated with the reserved GPIOs can be communicated to system firmware 408.

Further, electronic device 400 may include system firmware 408 to boot up electronic device 400 and to store a look-up table. Example system firmware 408 may include a BIOS, UEFI, or the like. Example look-up table may be stored in a database 410 and include antenna states indexed according to a frequency channel, a channel bandwidth, and a frequency band. In other words, the look-up table may be used to map the available antenna states to predetermined channel information. During operation system firmware 408 may receive channel information from WLAN module 404.

Further, system firmware 408 may determine a state of first antenna 402 corresponding to the received channel information using the look-up table. In one example, system firm are 408 may map the received channel information with the predetermined channel information in the look-up table to determine the state of antenna 402. In this example, the look-up table may indicate that the current antenna state may be an optimized tuning state, or may indicate that the determined antenna state may be the optimized tuning state. Accordingly, system firmware 408 may send control data (e.g., GPIOs) corresponding to the optimized tuning state to tune first antenna 402.

In one example, system firmware 408 may employ an artificial intelligence to generate a system management interrupt causing electronic device 400 to enter a system management mode upon receiving the channel information, re-packet the channel information with a system management mode protocol during the system management mode, and determine the state of first antenna 402 by analyzing the re-packeted channel information using the look-up table during the system management mode. Furthermore, system firmware 408 may switch first antenna 402 to operate in the determined state via toggling the reserved GPIOs of platform controller hub 406.

FIG. 4B is a schematic representation of example electronic device 400 of FIG. 4A, depicting additional features. For example, similarly named elements of FIG. 4B may be similar in structure and/or function to elements described with respect to FIG. 4A. As shown in FIG. 4B, electronic device 400 may include a second antenna 454 coupled to WLAN module 404 and platform controller hub 406. For example, first antenna 402 may be a main antenna and second antenna 454 may be an auxiliary antenna. In this example, system firmware 408 may switch first antenna 402 and second antenna 454 to operate in the determined state via toggling the reserved GPIOs (e.g. GPIO 1, GPIO 2, GPIO 3, and GPIO 4) of platform controller hub 406.

Further as shown in FIG. 4B, electronic device 400 may include a connector 452 to connect the reserved GPIOs, power (e.g., 3.3v/1.8v), and ground pins of platform controller hub 406 to antennas 402 and 454, for instance, via respective tuning circuits 464 and 466. In one example, connector 452 may be connected to reserved GPIO pins, a power pin, and a ground pin of platform controller hub 406 and also connected to antennas 402 and 454 using a tuning control cable.

In the example shown in FIG. 4B, electronic device 400 may be a laptop computer having a base housing 460 and a display housing 456 that may be rotatably, detachably, or twistably connected to base housing 460. For example, base housing 460 may house a keyboard, a battery, a touchpad, and so on. Display housing 456 may house a display 458 (e.g., a touchscreen display). Example display 458 may include liquid crystal display (LCD), light emitting diode (LED), electro-luminescent (EL) display, or the like. In other examples, display housing 456 and base housing 460 may house other components such as a camera, audio/video devices, and the like, depending on the functions of electronic device 400.

In the example shown in FIG. 4B, antennas 402 and 454 may be disposed in display housing 456. Further, base housing 460 may include a motherboard 462 (e.g., a printed circuit board). As shown in FIG. 48, WLAN module 404, platform hub controller 406, system firmware 408, and connector 452 may be disposed on motherboard 462 and electrically connected to each other via motherboard 462 to perform the functions described herein.

Further, electronic device 400 may include computer-readable storage medium including (e.g., encoded with) instructions executable by a processor to implement functionalities described herein. In some examples, the functionalities described herein, in relation to instructions to implement functions of components of electronic device 400 and any additional instructions described herein in relation to the storage medium, may be implemented as engines or modules including any combination of hardware and programming to implement the functionalities of the modules or engines described herein. The functions of components of electronic device 400 may also be implemented by a respective processor. In examples described herein, the processor may include, for example, one processor or multiple processors.

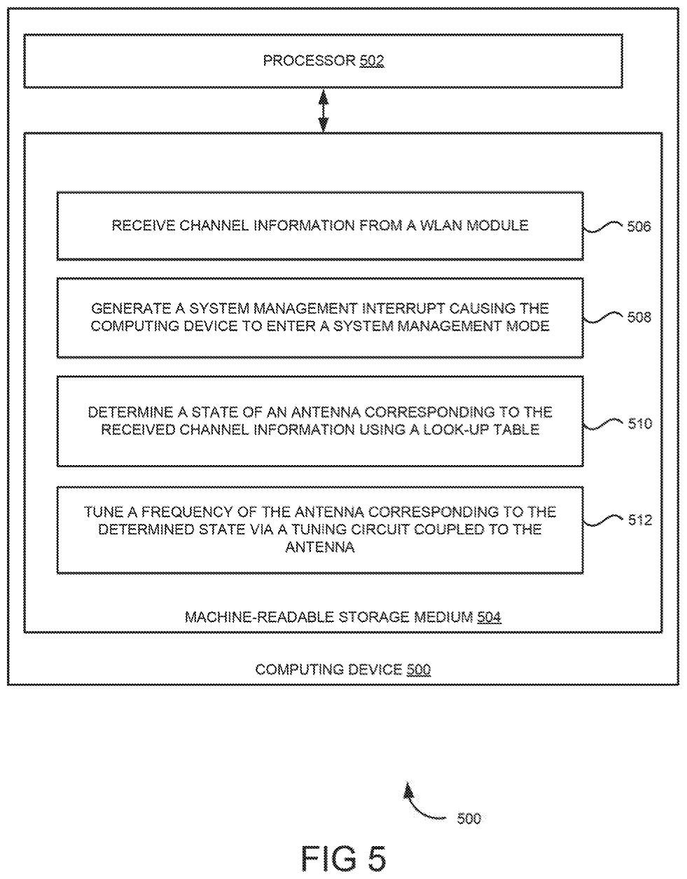

FIG. 5 is a block diagram of example computing device 500 including a non-transitory machine-readable storage medium 504, storing instructions to tune a frequency of an antenna based on channel information. Computing device 500 (e.g., a wireless device) may include a processor 502 and machine-readable storage medium 504 communicatively coupled through a system bus. Processor 502 may be any type of central processing unit (CPU), microprocessor, or processing logic that interprets and executes machine-readable instructions stored in machine-readable storage medium 504. Machine-readable storage medium 504 may be a random-access memory (RAM) or another type of dynamic storage device that may store information and machine-readable instructions that may be executed by processor 502. For example, machine-readable storage medium 504 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 504 may be a non-transitory machine-readable medium. In an example, machine readable storage medium 504 may be remote but accessible to computing device 500.

Machine-readable storage medium 504 may store instructions 506-512. In an example, instructions 506 may be executed by processor 402 to receive, by a system firmware, channel information from a WLAN module. Example channel information may include a channel number, a channel bandwidth, a frequency band, a received signal strength indicator (RSSI) value, and the like. Instructions 508 may be executed by processor 502 to generate, by the system firmware, a system management interrupt causing computing device 500 to enter a system management mode upon receiving the channel information.

Instructions 510 may be executed by processor 502 to determine a state of an antenna corresponding to the received channel information using a look-up table during the system management mode. In one example, instructions to determine the state of the antenna corresponding to the received channel information may include instructions to employ artificial intelligence to determine the state of the antenna corresponding to the received channel information using the look-up table. Further, instructions to determine the state of the antenna corresponding to the received channel information may include instructions to re-packet the channel information with a system management mode protocol during the system management mode and determine the state of the antenna by analyzing the re-packeted channel information using the look-up table during the system management mode.

Instructions 512 may be executed by processor 502 to tune a frequency of the antenna corresponding to the determined state via a tuning circuit coupled to the antenna. In one example, instructions to tune the frequency of the antenna corresponding to the determined state via the tuning circuit may include instructions to switch the antenna to operate in the determined state by controlling GPIOs to the tuning circuit. For example, consider an antenna may be designed with two states to cover ISM band, 2.4 GHz and 2.5 GHz. In this example, the antenna state can be switched, by the system firmware (e.g., BIOS) according to the truth table.

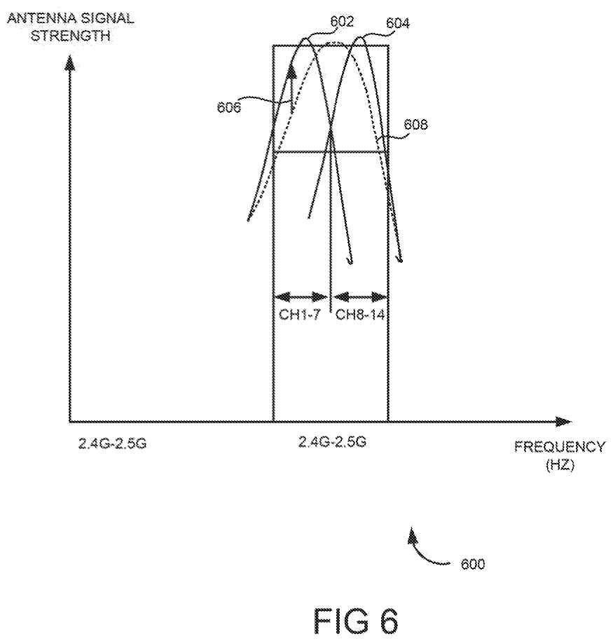

FIG. 6 illustrates an example graph 600 depicting a frequency versus signal strength characteristics of an antenna. As shown in FIG. 6, the antenna may be tuned into two optimized states using a look-up table as shown in characteristic curves 602 and 604. Characteristic curve 608 may represent frequency versus signal strength characteristics of an existing antenna design (e.g., without tuning). In one example, the signal strength of the antenna may be enhanced as shown by 606 in antenna state 1 (i.e., characteristic curve 602). Thus examples described herein may tune the antenna into an optimized state, enhance antenna gain, enhance Wi-Fi, enhance RSSI, and enhance WLAN throughput and performance.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A computing device comprising:
an antenna;
a tuning circuit to tune the antenna;
a wireless local area network (WLAN) module coupled to the antenna;
a system firmware to boot up the computing device; and
a look-up table residing in the system firmware, wherein the system firmware is to:
receive channel information from the WLAN module;
determine a state of the antenna corresponding to the received channel information using the look-up table; and
tune a frequency of the antenna comes ponding to the determined state via the tuning circuit.

2. The computing device of claim 1, wherein the system firmware is to:
generate a system management interrupt causing the computing device to enter a system management mode upon receiving the channel information;
re-packet the channel information with a system management mode protocol during the system management mode; and
determine the state of the antenna by analyzing the re-packeted channel information using the look-up table during the system management mode.

3. The computing device of claim 1, wherein the look-up table comprises predetermined antenna states to tune the antenna for transmit and receive applications as a function of a frequency channel, a channel bandwidth, and a frequency band.

4. The computing device of claim 1, wherein the channel information is selected from a group consisting of a channel number, a channel bandwidth, a frequency band, and a received signal strength indicator (RSSI) value.

5. The computing device of claim 1, wherein the system firmware is to:
detune the antenna when there is a specific absorption rate (SAR) concern.

6. An electronic device comprising:
a first antenna having a tuning capability;
a wireless local area network (WLAN) module coupled to the first antenna;
a platform controller hub communicatively coupled to the first antenna and having reserved general-purpose input outputs (GPIOs) to control the first antenna;
a system firmware to boot up the electronic device and to store a look-up table, wherein the system firmware is to:
receive channel information from the WLAN module;
determine a state of the first antenna corresponding to the received channel information using the look-up table; and
switch the first antenna to operate in the determined state via toggling the reserved GPIOs of the platform controller hub.

7. The electronic device of claim 6, wherein the system firmware is to employ an artificial intelligence to:
generate a system management interrupt causing the electronic device to enter a system management mode upon receiving the channel information;
re-packet the channel information with a system management mode protocol during the system management mode; and
determine the state of the first antenna by analyzing the re-packeted channel information using the look-up table during the system management mode.

8. The electronic device of claim 6, wherein the system firmware comprises a basic input/output system (BIOS) or a unified extensible firmware interface (UEFI).

9. The electronic device of claim 6, further comprising:
a second antenna coupled to the WLAN module and the platform controller hub, wherein the system firmware is to switch the first antenna and the second antenna to operate in the determined state via toggling the reserved GPIOs of the platform controller hub.

10. The electronic device of claim 6, further comprising:
a connector to connect the reserved GPIOs, power, and ground pins of the platform controller hub to the first antenna.

1. A non-transitory machine-readable storage medium encoded with instructions that, when executed by a computing device, cause a system firmware of the computing device to:
receive channel information from a WLAN module;
generate a system management interrupt causing the computing device to enter a system management mode upon receiving the channel information;
determine a state of an antenna corresponding to the received channel information using a look-up table during the system management mode; and
tune a frequency of the antenna corresponding to the determined state via a tuning circuit coupled to the antenna.

12. The non-transitory machine-readable storage medium of claim 11, wherein instructions to determine the state of the antenna corresponding to the received channel information comprises instructions to:
employ artificial intelligence to determine the state of the antenna corresponding to the received channel information using the look-up table.

13. The non-transitory machine-readable storage medium of claim 11, wherein instructions to determine the state of the antenna corresponding to the received channel information comprises instructions to:
re-packet the channel information with a system management mode protocol during the system management mode; and
determine the state of the antenna by analyzing the re-packeted channel information using the look-up table during the system management mode.

14. The non-transitory machine-readable storage medium of claim 11, wherein instructions to tune the frequency of the antenna corresponding to the determined state via the tuning circuit comprises:
instructions to switch the antenna to operate in the determined state by controlling general-purpose input outputs (GPIOs) to the tuning circuit.

15. The non-transitory machine-readable storage medium of claim 11, wherein the channel information is selected from a group consisting of a channel number, a channel bandwidth, a frequency band, and a received signal strength indicator (RSSI) value.
